(19) United States
(12) Patent Application Publication
(10) Pub. No.: US 2016/0377276 A1
(43) Pub. Date: Dec. 29, 2016

(54) In-wall occupancy sensor night light with alternate activation

(71) Applicant: Kevin A. Furry, Folsom, CA (US)

(72) Inventor: Kevin A. Furry, Folsom, CA (US)

(21) Appl. No.: 14/747,193

(22) Filed: Jun. 23, 2015

(51) Int. Cl. F21V 23/04; F21V 23/02; F21S 8/00

(52) U.S. Cl. CPC F21V 23/0471; F21S 8/035; F21V 23/02; F21V 23/04; F21V 23/0464; F21V 23/0435; F21Y 2101/02

(57) ABSTRACT

An electrical device includes a night light. The night light includes one or more light sources for emitting light. The device includes an occupancy detection sensor to detect occupancy within a monitored area in addition to a daylight sensor. The daylight sensor provides detection of ambient light and detection of other similar devices, which have activated, within a larger monitored area. The device optionally includes a power outlet. The device optionally includes alternate method to detect other devices, which have activated, within a larger monitored area.

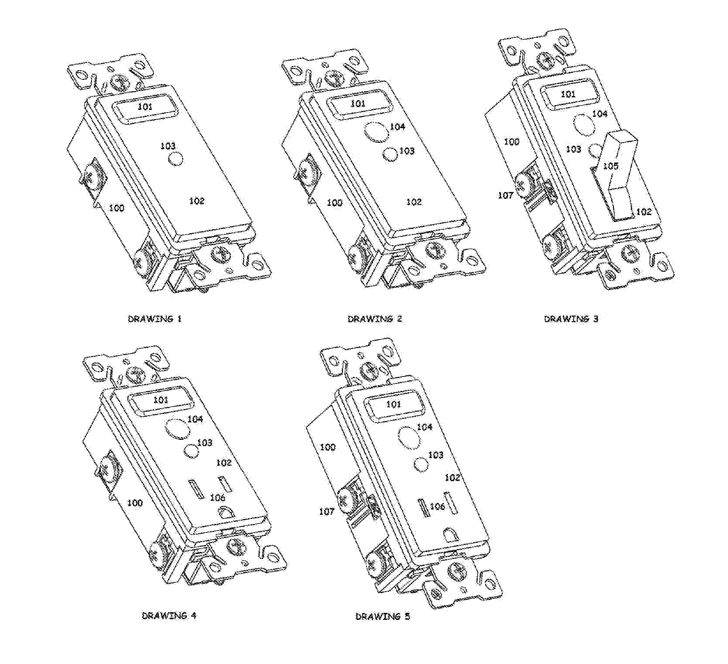

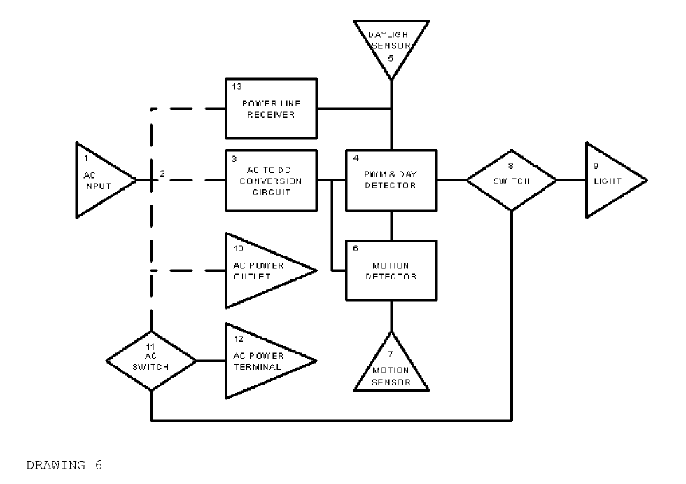

### U.S. PATENT DOCUMENTS

U.S. Pat. No. 5,673,022A September 1997 Patel; Jitendra

U.S. Pat. No. 6,010,228A January 2000 Blackman

2001/0046130A1 Nov. 2001 Cunningham

2004/0009700A1 Jan. 2004 Patel; Jitendra

U.S. Pat. No. 7,273,983B1 Sep. 2007 Rintz

2012/0068612A1 Mar. 2012 Ebeling

2014/0028210A1 Jan. 2014 Maxik

U.S. Pat. No. 2,905,779 September 1959 Schmier

U.S. Pat. No. 4,787,722 November 1988 Claytor

U.S. Pat. No. 5,924,486 July 1999 Ehlers et al.

U.S. Pat. No. 6,285,912 September 2001 Ellison et al.

U.S. Pat. No. 6,648,496 November 2003 Elghoroury et al.

U.S. Pat. No. 6,894,434 May 2005 Kosoff

U.S. Pat. No. 6,967,565 November 2005 Lingemann

U.S. Pat. No. 7,130,719 October 2006 Ehlers et al.

U.S. Pat. No. 7,274,975 September 2007 Miller

D59564 July 2009 Schmalz et al.

U.S. Pat. No. 7,649,472 January 2010 Paterno

U.S. Pat. No. 7,724,557 May 2010 Ganta Papa Rao Bla et al.

D619275 July 2010 Pineault et al.

D652549 January 2012 Pineault et al.

834643 January 2013 Goyal et al.

2008/0079568 April 2008 Primous et al.

2009/0256483 October 2009 Gehman et al.

U.S. Pat. No. 8,646,936 June 2010 Goyal et al.

2011/009394 April 2011 Goyal et al.

2011/0298392 December 2011 Goyal et al.

2011/0301776 December 2011 Goyal et al.

59564 March 2008 Schmatz et al.

### OTHER REFERENCES

WN-100 Motion Sensor Nightlight Switch Installation Instructions; www.wattstopper.com May 2005.

### TECHNICAL FIELD

The present invention relates generally to electrical wiring devices and more particularly, to electrical wiring devices that include a night light and features to interconnect devices to other similar devices.

### BACKGROUND

There are many situations that arise where people desire a night light in a room, hallway, or other area whether or not that room, hallway, or other area has a lighting load, such as a bedroom light, electrically coupled to an electrical wiring device. A lighting load, or associated lighting load, is a light source that is remotely located from the electrical wiring device but is electrically coupled to one or more electrical contacts of the electrical wiring device using one or more electrical wires. Some examples of lighting loads include, but are not limited to, luminaires and lamps. The night light generally provides lower level lighting than the lighting load. In one situation, some people can use night lights in their bedroom or hallway so that they can walk around, for example, to the restroom or to the kitchen, without bumping into anything when they wake up in the middle of the night. In another situation, some people can use night lights in their bedroom so that they can locate items, for example, their watch or their glasses, when they wake up in the middle of the night. In yet another situation, parents can use night lights in their children's bedroom so that they can enter their children's bedroom in the middle of the night to monitor their children without having to turn on the lighting load, or bedroom light in one exemplary scenario, and possibly disturb the children. These are a few exemplary situations for what people oftentimes use night lights. As exemplified, night lights provide sufficient lighting for people at night time to perform different tasks without having to turn on the lighting loads that are electrically coupled to the electrical wiring device.

Conventional night lights are typically plugged into an electrical receptacle, which is usually located closer to floor level. These conventional night lights provide continuous lighting around the night light. Continuous lighting provides improved safety but for many people interfere with their ability to sleep. These conventional night lights are easily removed and misplaced and/or damaged. Regardless of the purpose of the night light or the desires of the end-users, the conventional night light creates low intensity lighting which cannot be avoided and in some cases will interfere with sleep.

### SUMMARY

An exemplary embodiment of the present invention is an electrical device including a night light. The night light includes one or more light sources for emitting light such as light emitting diodes (“LEDs”). The device includes a ambient light sensor. The ambient light sensor provides detection of ambient light and detection of other similar devices emitting pulse width modulated light when activated within a larger monitored area.

Another exemplary embodiment of the present invention is an electrical device including a night light. The night light includes one or more light sources for emitting light such as light emitting diodes (“LEDs”). The device includes an occupancy detection sensor to detect occupancy within a monitored area in addition to a daylight sensor. The daylight sensor provides detection of ambient light and detection of other similar devices emitting pulse width modulated light when activated within a larger monitored area.

Another exemplary embodiment of the present invention is an electrical device including a night light. The night light includes one or more light sources for emitting light such as light emitting diodes (“LEDs”). The device includes a power line receiver to detect pulse width modulated power signals from other similar devices emitting pulse width modulated power line signals when activated within a larger monitored area.

Other exemplary embodiment of the present invention includes additional features to the previous exemplary embodiment of the present invention, like power switch, power outlet or output power connectors.

### BRIEF DESCRIPTION OF THE DRAWINGS

The foregoing and other features and aspects of the invention are best understood with reference to the following description of certain exemplary embodiments, when read in conjunction with the accompanying drawings, wherein:

DRAWING 1 is a perspective view of an in-wall night light in accordance with an exemplary embodiment of the present invention;

DRAWING 2 is a perspective view of an in-wall night light with occupancy sensor in accordance with an exemplary embodiment of the present invention;

DRAWING 3 is a perspective view of an in-wall night light with occupancy sensor and power switch in accordance with an exemplary embodiment of the present invention;

DRAWING 4 is a perspective view of an in-wall night light with occupancy sensor and power outlet in accordance with an exemplary embodiment of the present invention;

DRAWING 5 is a perspective view of an in-wall night light with occupancy sensor and power output connector in accordance with an exemplary embodiment of the present invention;

DRAWING 6 is a schematic block diagram of operating mode selections for the in-wall occupancy sensor with ambient light sensor of DRAWING 1-5 in accordance with an exemplary embodiment of the present invention;

The drawings illustrate only exemplary embodiments of the invention and are therefore not to be considered limiting of its scope, as the invention may admit to other equally effective embodiments.

### BRIEF DESCRIPTION OF EXEMPLARY EMBODIMENTS

The present invention is directed to in-wall night light devices triggered by occupancy sensors. Although the description of exemplary embodiments is provided below in conjunction with an in-wall night light with occupancy sensor, alternate embodiments of the invention are applicable to other types of electrical wiring devices having an night light occupancy sensor including, but not limited to, receptacles, switches, and any other electrical wiring device known to people having ordinary skill in the art. The invention is better understood by reading the following description of non-limiting, exemplary embodiments with reference to the attached drawings, wherein like parts of each of the figures are identified by like reference characters, and which are briefly described as follows.

DRAWING 1 is a perspective view of an in-wall night light body 100 with surface 102 supporting daylight sensor 103 and (LED) Light Emitting Diode 101 in accordance with an exemplary embodiment of the present invention. Drawing 6 is a schematic showing AC power input 1 connected to AC to DC conversion circuit 3 to provide DC power to operate all portions of the night light circuitry 4,5,6,7,8,9,13. A daylight sensor 5 is connected to a (PWM) Pulse Width Modulation and day light detector 4. The electrical signals from the daylight sensor 5 is analyzed by the PWM and day light detector circuit 4 to detect low ambient light or PWM activation signals from another night light's LED. When the day light sensor 5 detects low ambient light signal and detects a PWM signal, an activation signal is sent to the electronic switch 8 to enable power to energize the LED light 9. The energizing signal is generated in the form of a PWM signal to the LED light.

DRAWING 2 is a perspective view of an in-wall night light body 100 with surface 102 supporting daylight sensor 103, motion sensor 104 and (LED) Light Emitting Diode 101 in accordance with an exemplary embodiment of the present invention. Drawing 6 is a schematic showing AC power input 1 connected to AC to DC conversion circuit 3 to provide DC power to operate all portions of the night light circuitry 4,5,6,7,8,9,13. A motion sensor 7 is connected to motion detector 6 which is connected to PWM and daylight detector 4. A daylight sensor 5 is also connected to the PWM and day light detector 4. The electrical signals from the daylight sensor 5 and motion detector 6 are analyzed by the PWM and day light detector circuit 4 to detect low ambient light, PWM activation signal from another night light's LED, or motion in front of the device. When the day light sensor 5 detects low ambient light signal and detects a PWM activation signal or motion signal, a activation signal is sent to the electronic switch 8 to enable power to energize the LED light 9. The energizing signal is generated in the form of a PWM signal to the LED light 9.

DRAWING 3 is the same exemplary embodiment as described before for drawing 1 or drawing 2 with the addition of a power switch 105 and AC output terminal 107. Drawing 6 is a schematic described before for drawing 1 or drawing 2. In addition drawing 6 is showing AC input 1 connected to the AC switch 11 which is connected to AC power terminal 12. When the AC switch 11 is moved into a conductive position AC power is routed from AC input 2 to the AC power terminal 12.

DRAWING 4 is the same exemplary embodiment as described before for drawing 1 or drawing 2 with the addition of a power outlet 106. Drawing 6 is a schematic described before for drawing 1 or drawing 2. In addition drawing 6 is showing AC input 1 connected to the power outlet 10. The power outlet 10 is energized when AC input 1 is energized.

DRAWING 5 is the same exemplary embodiment as described before for drawing 1 or drawing 2 with the addition of a power outlet 106 and AC output terminal 107. Drawing 6 is a schematic described before for drawing 1 or drawing 2. In addition drawing 6 is showing AC input 1 connected to the AC switch 11 which is connected to AC power terminal 12. When the PWM and daylight detector energizes the switch 8 it also energizes the AC switch 11 allowing AC power to flow from AC input 1 to AC output terminal 12. In addition drawing 6 is showing AC input 1 connected to the power outlet 10. The power outlet 10 is energized when AC input 1 is energized.

DRAWING 6 is a schematic described before for drawing 1 through 5. Showing AC power input 1 connected to AC to DC conversion circuit 3 to provide DC power to operate all portions of the night light circuitry 4,5,6,7,8,9,13. A daylight sensor 5 and/or a power line receiver circuit 13 are connected to a (PWM) Pulse Width Modulation and day light detector 4. The PWM detector 4 analyzes incoming signals looking for a specific pulse width modulated frequency which is indicative of a similar matching device being activated or de-activated. The PWM detector 4 is capable of detecting input or generating output PWM signals. If the PWM detector 4 detects an activation PWM modulated signal and/or motion sensor signal and ambient low light levels, it can output a PWM modulated activation signal increasing from 0% to 100% duty cycle at 15 khz sent to the electronic switch 8 to enable power to energize the LED lighting 9 causing the LED light 9 to fade from dark to bright. When the day light sensor 5 detects high ambient light signal and/or the PWM detector 4 does not detect a PWM signal, it can output a PWM modulated de-activation signal decreasing from 100% to 0% duty cycle at 10 khz sent to the electronic switch 8 to enable power to energize the LED lighting 9 causing the LED light 9 to fade from bright to dark.

What is claimed is:

1. An electrical device, comprising: a night light, the night light comprising one or more light sources for emitting light; an ambient light detector, the ambient light detector used to detect at least one other activated similar device external to the electrical device, wherein the light emitted from the electrical device is activated upon the detection of another similar device becoming activated.

2. The electrical device of claim 1, wherein the electrical device further comprises a power outlet.

3. The electrical device of claim 1, wherein the electrical device further comprises a power switch.

4. The electrical device of claim 1, wherein the electrical device further comprises a power output terminal.

5. The electrical device of claim 1, wherein the night light further comprises an occupancy detector, wherein the occupancy detector can activate the light sources upon detection of occupancy within a monitored area.

6. The electrical device of claim 5, wherein the electrical device further comprises a power outlet.

7. The electrical device of claim 5, wherein the electrical device further comprises a power switch.

8. The electrical device of claim 5, wherein the electrical device further comprises a power output terminal.

9. An electrical device, comprising: a night light, the night light comprising one or more light sources for emitting light; a radio receiver, wherein the radio receiver is used to detect at least one other activated similar device external to the electrical device, wherein the light emitted from the electrical device is activated upon the detection of another similar device becoming activated.

10. The electrical device of claim 9, wherein the electrical device further comprises a power outlet.

11. The electrical device of claim 9, wherein the electrical device further comprises a power switch.

12. The electrical device of claim 9, wherein the electrical device further comprises a power output terminal.

13. The electrical device of claim 9, wherein the night light further comprises an occupancy detector, wherein the occupancy detector can activate the light sources upon detection of occupancy within a monitored area.

14. The electrical device of claim 13, wherein the electrical device further comprises a power outlet.

15. The electrical device of claim 13, wherein the electrical device further comprises a power switch.

16. The electrical device of claim 13, wherein the electrical device further comprises a power output terminal.

17. An electrical device, comprising: a night light, the night light comprising one or more light sources for emitting light; a power line receiver, wherein the power line receiver is used to detect at least one other activated similar device external to the electrical device, wherein the light emitted from the electrical device is activated upon the detection of another similar device becoming activated.

18. The electrical device of claim 17, wherein the electrical device further comprises a power outlet.

19. The electrical device of claim 17, wherein the electrical device further comprises a power switch.

20. The electrical device of claim 17, wherein the electrical device further comprises a power output terminal.

21. The electrical device of claim 17, wherein the night light further comprises an occupancy detector, wherein the occupancy detector can activate the light sources upon detection of occupancy within a monitored area.

22. The electrical device of claim 21, wherein the electrical device further comprises a power outlet.

23. The electrical device of claim 21, wherein the electrical device further comprises a power switch.

24. The electrical device of claim 21, wherein the electrical device further comprises a power output terminal.
